(19) United States
(12) Patent Application Publication
(10) Pub. No.: US 2026/0027698 A1
(43) Pub. Date: Jan. 29, 2026

(54) WORK APPARATUS

(71) Applicant: Andreas Stihl AG & Co. KG, Waiblingen (DE)

(72) Inventors: Michael Dieterich, Waiblingen (DE); Johanna Koch, Marbach-Rielingshausen (DE); Andrea Hein, Ehningen (DE)

(21) Appl. No.: 19/279,868

(22) Filed: Jul. 24, 2025

(30) Foreign Application Priority Data
Jul. 24, 2024 (DE) 10 2024 121 109.1

(51) Int. Cl. B25G 3/00

(52) U.S. Cl. CPC B25G 3/00

(57) ABSTRACT

A handle is for a manually operated work apparatus. The handle has a shaft, which has a fastening end and a free end. The handle is fixed on the fastening end. The handle has a first operator-controlled element for controlling the work apparatus. The first operator-controlled element is arranged adjacent to the free end of the shaft. The handle has an indication arrangement including an indication element for conveying operational information to the operator. The indication arrangement is arranged adjacent to the fastening end of the shaft.

### CROSS-REFERENCE TO RELATED APPLICATIONS

This application claims priority of German patent application no. 10 2024 121 109.1, filed Jul. 24, 2024, the entire content of which is incorporated herein by reference.

### BACKGROUND

Work apparatuses with bike-type handlebars are known, wherein two handles are provided on a single handlebar. An operator-controlled element for controlling the work apparatus is provided on at least one of the two handles. Moreover, it is customary for such work apparatuses to have additional operator controlled means on the handles for controlling or indicating additional functions of the work apparatus. However, these may interfere with the performance of various work movements by the operator.

### SUMMARY

It is an object of the disclosure to provide a handle for a work apparatus via which various work movements can be carried out ergonomically and, at the same time, a number of apparatus functions can be indicated or controlled. It is another object of the disclosure to provide a work apparatus via which various work movements can be carried out ergonomically and, at the same time, a number of apparatus functions can be indicated and/or controlled.

This object is achieved in respect of the handle for a work apparatus by a handle according to various embodiments of the disclosure. In respect of the work apparatus, the object is achieved by a work apparatus according to various embodiments of the disclosure.

The handle according to the disclosure for a manually operated work apparatus has a shaft, which has a fastening end and a free end and extends from the fastening end to the free end over a shaft length, wherein the shaft of the handle is fixed on the fastening end. The handle has a first operator-controlled element for controlling the work apparatus. The first operator-controlled element is arranged adjacent to the free end of the shaft. The handle has an indication arrangement including an indication element for conveying operational information to the operator. The indication arrangement is arranged in such a way that a distance between the indication arrangement and the fastening end is less than half the shaft length (a). In particular, the indication arrangement is arranged adjacent to the fastening end of the shaft.

By virtue of the arrangement of the indication arrangement close to the fastening end of the shaft, the operator can grip the handle at the free end and between the free end and the fastening end without accidentally touching or covering the indication arrangement. To perform a backward and forward movement when mowing, for example, the operator can grip the handle between the fastening end and the free end. To perform an up and down movement that is more of a beating movement when chopping, the operator can grip the handle at the free end. Ergonomic working is thus ensured. Via the indication arrangement arranged adjacent to the fastening end of the shaft, it is possible to indicate and/or control at least one additional apparatus function.

In particular, the indication element of the indication arrangement is a display. In particular, the indication element of the indication arrangement can be a touch-sensitive display. Operational information on the work apparatus can thus be conveyed to the operator. This can be, for example, the filling level of the energy source, the operating mode of the work apparatus or similar states or system information on the work apparatus.

In particular, it is envisaged that the indication arrangement includes an additional operator-controlled element for user input. Via the additional operator-controlled element, it is thus possible for the user to make inputs to the work apparatus. In particular, the additional operator-controlled element is arranged in the display. The indication arrangement is thus of compact configuration. In an alternative embodiment of the handle, provision can be made for the indication arrangement to have a plurality of additional operator-controlled elements, which, in particular, are arranged in the display.

If the display is configured as a touch-sensitive display, this can serve as an indication element and simultaneously as an additional operator-controlled element.

Provision is advantageously made for the indication element to be arranged on the shaft of the handle. In particular, the handle has an outer side, which is provided at least partially for the purpose of resting against a palm of a hand of a user, wherein the handle has an inner side situated opposite the outer side, wherein the indication arrangement is arranged on the inner side of the handle.

The arrangement of the operator-controlled element on the inner side of the handle makes it significantly easier for the operator to see and/or actuate the indication arrangement.

In particular, it is envisaged that the handle, in particular the shaft, includes a first holding section, wherein the first holding section is formed between the fastening end and the free end of the handle. If the operator grips the handle on its first holding section between the free end and the fastening end, the operator can ergonomically perform backward and forward movements when mowing.

In particular, the handle includes a second holding section, wherein the second holding section is formed on the free end of the handle as a support surface for supporting a hand of the operator. If the operator places one hand on the second holding section of the handle, they can perform upward and downward movements of the work apparatus in a particularly ergonomic way.

In particular, it is envisaged that the indication arrangement is arranged outside the first holding section and outside the second holding section. In this way, accidental covering or touching of the indication arrangement by the hand of the operator can be avoided. In particular, the indication element is arranged between the first holding section and the fastening end.

### BRIEF DESCRIPTION OF DRAWINGS

The invention will now be described with reference to the drawings wherein: FIG. 1 shows a schematic perspective illustration of an operator with a work apparatus; and,

FIG. 2 shows a perspective illustration of a handle of the work apparatus from FIG. 1.

### DETAILED DESCRIPTION

FIG. 1 shows a work apparatus 1. In the embodiment, the work apparatus 1 is a manually operated work apparatus, in particular a portable manually operated work apparatus or a manually operated work apparatus carried on the back. The term “portable” means that the work apparatus 1 is configured in such a way that it can be carried during operation as intended. The term “carried on the back” means that the work apparatus 1 is configured in such a way that it is substantially carried on the back of the operator 51 during operation as intended. For this purpose, the work apparatus 1 has a means for enabling it to be carried on the back. In the embodiment, the work apparatus 1 is a brushcutter. The work apparatus 1 can also be configured as a string trimmer, blower, sprayer, pole saw or similar work apparatus.

FIG. 1 shows schematically a user 51 carrying the work apparatus 1. In particular, the work apparatus 1 has a guide tube 2. A work tool unit 3, in the embodiment a work tool head with a work tool configured as a cutting blade 70, is arranged at one end 42 of the guide tube 2. A housing 4 is arranged at the other end 73 of the guide tube 2.

In the embodiment, a schematically illustrated drive motor 26 is arranged in the housing 4. The drive motor 26 can be, for example, an electric motor, in particular an electric motor supplied with energy by a rechargeable battery, or an internal combustion engine. The operator 51 carries the work apparatus 1 via a carrying strap 74. The carrying strap 74 at least partially, in particular largely, takes the weight of the work apparatus 1 during operation. The carrying strap 74 holds the work apparatus 1 at a suspension point A. The work apparatus 1 is advantageously suspended from the carrying strap 74 in such a way that the work apparatus 1 hangs freely from the carrying strap 74 in a working position, that is, a position in which the work tool unit 3 is lower than the housing 4.

The center of gravity S of the work apparatus 1 and the weight F are indicated schematically in FIG. 1. The center of gravity S of the work apparatus 1 is advantageously offset in the direction of the work tool unit 3, relative to the suspension point A. As a result, the work apparatus 1 hangs from the carrying strap 74 in such a way that the work tool unit 3 is lower than the housing 4 of the work apparatus 1.

A handlebar 5 is fixed on the guide tube 2 to enable the work apparatus 1 to be guided. Via the handlebar 5, it is, in particular, the forces required for the feed motion of the work tool 70 that are introduced during the operation of the work apparatus 1. The feed motion can be, for example, a backward and forward movement when mowing or an up-and-down beating movement when chopping. The direction of movement when mowing is indicated schematically in FIG. 1 by the double arrow M, and the direction of movement when chopping is indicated by the double arrow H.

The handlebar 5 is what is referred to as a bike-type handlebar. The handlebar 5 includes a handlebar rod 43. The handlebar rod 43 preferably extends approximately transversely to the guide tube 2. There is a handle 6, 7 arranged at each of the two ends of the handlebar rod 43. The handles 6, 7 have inner sides 29, which are arranged facing one another. The handles 6, 7 have outer sides 28, which face away from one another. The outer sides 28 of the handles 6, 7 rest against the palm of the hand 52 of the user 51. The inner sides 29 are therefore those sides of the handles 6, 7 which are close to one another. The outer sides 28 are those sides of the handles 6, 7 which are remote from one another. The handles 6, 7 have front sides 39. The front side 39 of each handle 6, 7 is that side of the handle 6, 7 which faces away from the operator 51 during operation of the work apparatus 1 as intended. The inner side 29 and the outer side 28 of the handle 6, 7 are connected via the front side 39 of the handle 6, 7. The handles 6, 7 have back sides 40. The back side 40 of each handle 6, 7 is that side of the handle 6, 7 which faces the operator 51 during operation of the work apparatus 1 as intended. The inner side 29 and the outer side 28 of the handle 6, 7 are connected via the back side 40 of the handle 6, 7. During the operation of the work apparatus 1 as intended, the apparatus is operated by the operator 51, wherein the work tool 70 is in motion and in engagement with the material to be acted upon.

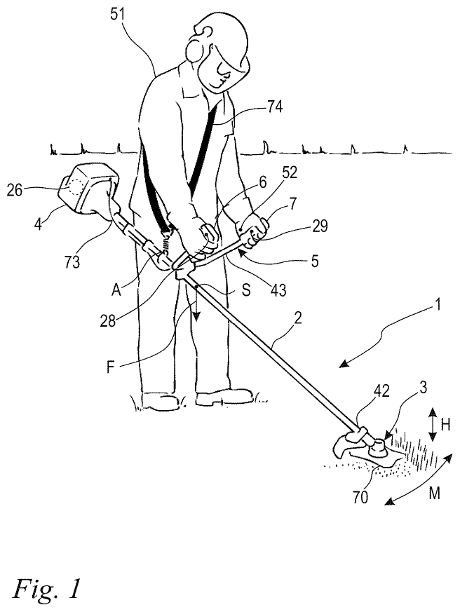

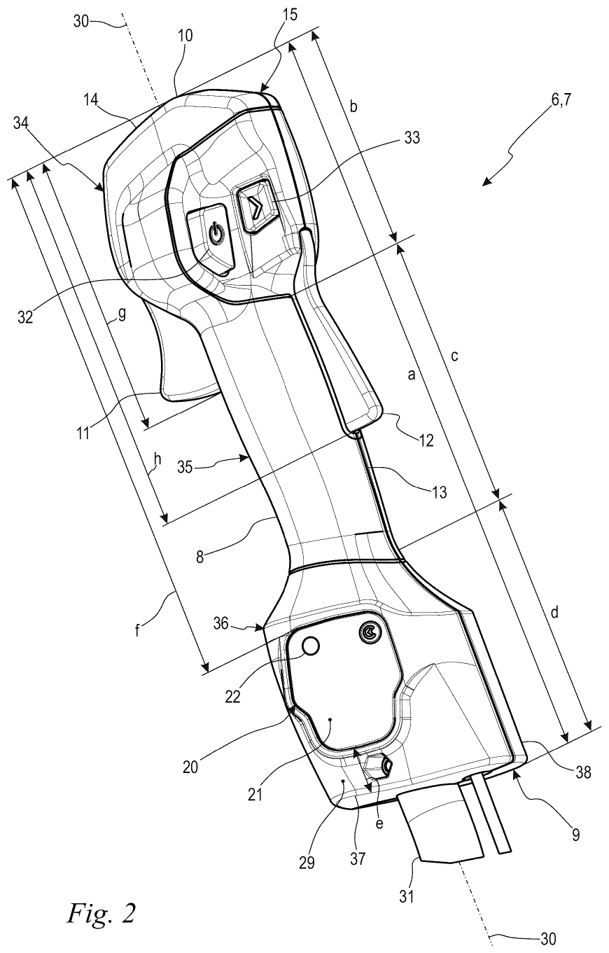

FIG. 2 shows the handle 6, 7. The handle 6, 7 has a shaft 8. The shaft 8 has a fastening end 9 and a free end 10. The shaft 8 extends from the fastening end 9 to the free end 10, in particular along a longitudinal center axis 30. The shaft 8 has a shaft length a which corresponds to the distance between the free end 10 and the fastening end 9. The shaft length a is measured, in particular, along the longitudinal center axis 30. The shaft 8 is fixed on the fastening end 9. The handle 6, 7 includes, in particular, a first holding section 13, in which the operator 51 can grip the handle 6, 7. The first holding section 13 is arranged on the shaft 8 between the fastening end 9 of the handle 6, 7 and the free end 10 of the handle 6, 7. The first holding section 13 of the handle 6, 7 is configured in such a way that the handle 6, 7 can be gripped in the first holding section 13.

As shown in FIG. 2, the handle 6, 7 includes at least one first operator-controlled element 11. The first operator-controlled element 11 is configured, in particular, for controlling the work apparatus 1. In the embodiment under consideration, the first operator-controlled element 11 is configured for controlling the drive motor 26, in particular for controlling the speed of the drive motor 26. The first operator-controlled element 11 is arranged adjacent to the free end 10. The first operator-controlled element 11 extends into the first holding section 13 of the handle 6, 7. The first operator-controlled element 11 is arranged on the handle 6, 7 in such a way that the operator 51 can actuate the first operator-controlled element 11 with the hand that is gripping the handle 6, 7 in the first holding section 13. The first operator-controlled element 11 is, in particular, configured as a pivoted lever.

As shown in FIG. 2, the handle 6, 7 includes, in particular, a second operator-controlled element 12. The second operator-controlled element 12 is configured, in particular, as a blocking element, in particular as a blocking lever. As a blocking element, the second operator-controlled element 12 enables the actuation of the first operator-controlled element 11 in an actuated position. As a blocking element, the second operator-controlled element 12 blocks the actuation of the first operator-controlled element 11 in an unactuated position. In the embodiment under consideration, it is envisaged that the operator 51 can actuate the first operator-controlled element 11 only if they have first actuated the second operator-controlled element 12. The blocking and release of the first operator-controlled element 11 by the second operator-controlled element 12 is performed, in particular, mechanically and/or electronically. The second operator-controlled element 12 is, in particular, arranged on the handle 6, 7 adjacent to the free end 10 of the shaft 8. The second operator-controlled element 12 extends into the first holding section 13 of the shaft 8. The operator 51 can actuate the second operator-controlled element 12 using the hand with which they are gripping the first holding section 13 of the shaft 8.

As shown in FIG. 2, the handle 6, 7 includes, in particular, a third operator-controlled element 32. Moreover, the handle 6, 7 includes a fourth operator-controlled element 33. The third operator-controlled element 32 is arranged adjacent to the free end 10 of the handle 6, 7. The third operator-controlled element 32 is used, in particular, to switch the work apparatus 1 on and off. The third operator-controlled element 32 is configured as an ON/OFF switch of the work apparatus 1. If the work apparatus 1 has been switched on by the third operator-controlled element 32, the work apparatus 1 is ready for operation. The operator 51 can then control the drive motor 26 by actuating the second operator-controlled element 12 and the first operator-controlled element 11. The fourth operator-controlled element 33 is arranged adjacent to the free end 10 of the handle 6, 7. Via the fourth operator-controlled element 33, it is possible to switch a function of the work apparatus 1.

As shown in FIG. 2, the handle 6, 7 includes a second operator-controlled element 14. The second holding section 14 is formed at the free end 10 of the handle 6, 7, in particular of the shaft 8. The second holding section 14 is formed on the handle 6, 7 as a support surface 15 for supporting the heel of the hand of the operator 51. The support surface 15 is configured in such a way that the operator 51 can grasp the handle 6, 7 on the end face at the free end 10. In the region of the second holding section 14, no operator-controlled elements are provided in order to ensure that the operator 51 does not accidentally press operator-controlled elements when resting their hand on the second holding section 14. When the hand is resting on the second holding section 14 of the handle 6, 7, the operator can exert the force required to move the work apparatus 1 in the direction of movement with the double arrow H when chopping.

As shown in FIG. 2, the shaft 8 of the handle 6, 7 in the embodiment under consideration is fixed via its fastening end 9 on a further shaft 31. The shaft 8 of the handle 6, 7 at least partially accommodates the further shaft 31. The further shaft 31 is, in particular, configured as a tube. In particular, a section of the further shaft 31 is part of the handle 6, 7 and, in particular, at the same time a section thereof is part of the handlebar grip 5, in particular part of the handlebar rod 43. In an alternative embodiment, provision may also be made for the handle 6, 7 to be fixed via its fastening end 9 on a main body of the work apparatus 1, in particular on the housing of the work apparatus 1.

As shown in FIG. 2, the handle 6, 7 includes an indication arrangement 20. In the embodiment, the indication arrangement 20 includes an indication element 21. Via the indication element 21, system information on the work apparatus 1 can be conveyed to the operator 51. In the present case, the indication element 21 is configured as a display. The indication arrangement 20 is arranged in such a way that a distance e between the indication arrangement 20 and the fastening end 9 is less than half the shaft length a. In particular, the indication arrangement 20 can be arranged on the shaft 8 or the further shaft 30. In particular, the indication arrangement 20 is arranged adjacent to the fastening end 9. The indication arrangement 20 is preferably arranged on the shaft 8 in such a way that the distance e between the indication arrangement 20 and the fastening end 9 is less than a distance f between the indication arrangement 20 and the free end 10. In particular, the two distances e, f are measured in the direction of the longitudinal center axis 30 of the handle 6, 7. Moreover, the first operator-controlled element 11 has a maximum distance g from the free end 10. The second operator-controlled element 12 has a maximum distance h from the free end 10. In particular, the maximum distances g, h are measured in the direction of the longitudinal center axis 30. A “distance” is the spatial separation between two points. The distance between two objects means that those points on the objects are chosen at which the objects are at the shortest distance from one another. The maximum distance between two objects means that those points on the objects are chosen at which the objects are at the greatest distance from one another. The maximum distance g between the free end 10 and the first operator-controlled element 11 is less than the distance h between the free end 10 and the second operator-controlled element 12. The distance f is greater than the maximum distance g and greater than the maximum distance h. The distance f between the free end 10 and the indication arrangement 20 corresponds, in particular, to at least 1.5 times, in particular at least 1.8 times, in particular approximately 2 times the maximum distance g between the free end 10 and the first operator-controlled element 11. The distance f between the free end 10 and the indication arrangement 20 corresponds, in particular, to at least 1.2 times, in particular at least 1.3 times, in particular approximately 1.4 times the maximum distance h between the free end 10 and the second operator-controlled element 12.

As shown in FIG. 2, the indication arrangement 20 includes, in particular, an additional operator-controlled element 22. In FIG. 2, the additional operator-controlled element 22 is illustrated schematically as a circle. User input can be performed by actuating the additional operator-controlled element 22. The additional operator-controlled element 22 is preferably arranged in the indication element 21. The indication arrangement 20 includes, in particular, a control board (not illustrated specifically). The additional operator-controlled element 22 and the indication element 21 of the indication arrangement 20 are, in particular, operatively connected, in particular directly, to the control board of the indication arrangement 20. In an alternative embodiment of the handle 6, 7, provision may also be made for the indication arrangement 20 to have further operator-controlled elements alongside the additional operator-controlled element 22.

Provision may also be made for the display to be a touch-sensitive display. If the display 21 is configured as a touch-sensitive display, user inputs may preferably also be made via the display. In such an embodiment, the touch-sensitive display is the indication element 21 and also the additional operator-controlled element 22.

As shown in FIG. 2, the indication arrangement 20 is, in particular, arranged on the handle 6, 7 adjacent, in particular directly adjacent, to the fastening end 9. The indication arrangement 20 is arranged, in particular, outside the first holding section 13 and/or outside the second holding section 14. During the operation of the work apparatus 1 as intended, no hand of the operator is thus resting on the indication arrangement 20, thereby also ensuring that the view of the indication element 21 of the indication arrangement 20 remains unobstructed for the operator. The indication arrangement 20 is arranged, in particular, between the fastening end 9 of the handle 6, 7 and the first holding section 13 of the handle 6, 7. As a particular preference, the indication arrangement 20 is arranged on the inner side 29 of the handle 6, 7, on the back side 40 of the handle 6, 7 or in a region of the handle 6, 7 between the inner side 29 and the back side 40 of the handle 6, 7. If the indication arrangement 20 is arranged in a region of the handle 6, 7 between the inner side 29 and the back side 40 of the handle 6, 7, the indication arrangement 20 is aligned toward the operator 51. Thus, the indication arrangement 20, in particular the indication element 21, is aligned so as to be particularly visible to the operator 51.

As shown in FIG. 2, the handle 6, 7 is of dumbbell-like configuration. In the present case, the handle 6, 7 can be divided into three sections, namely into a head section 34, a middle section 35 and a foot section 36. The free end 10 of the handle 6, 7 is formed on the head section 34 of the handle 6, 7. In particular, the third operator-controlled element 32 and/or the fourth operator-controlled element 33 are arranged on the head section 35. The head section 34 is adjoined by the middle section 35. The middle section 35 corresponds to the first holding section 13. The middle section 35 is then adjoined by the foot section 36 of the handle 6, 7. The fastening end 9 of the handle 6, 7 is formed on the foot section 36. In particular, the indication arrangement 20 is arranged on the foot section 36.

As shown in FIG. 2, in particular the head section 34 and/or the foot section 36 are thickened relative to the middle section 35. The thickening relates to the extent of the head section 34 and/or the foot section 36 radially with respect to the longitudinal central axis 30 of the handle 6, 7. The head section 34 and/or the foot section 36 thus form/forms a stop in the direction of the longitudinal center axis 30 of the handle 6, 7, starting from the middle section 35, for the hand of the operator 51 gripping the middle section 35.

As shown in FIG. 2, the shaft 8 of the handle 6, 7 extends over the shaft length a in the direction of its longitudinal center axis 30 from its free end 10 to its fastening end 9. The head section 34 extends over a length c along the longitudinal center axis 30 from the free end 10 to the middle section 35. The middle section 35 extends over a length c along the longitudinal center axis 30 from the head section 34 to the foot section 36. The foot section 36 extends over a length d along the longitudinal center axis 30 from the middle section 35 to the fastening end 9. The length b of the head section 34 is at least 15%, preferably at least 25%, of the shaft length a of the shaft 8 of the handle 6, 7. The length d of the foot section 36 is at least 15%, preferably at least 25%, of the shaft length a of the shaft 8 of the handle 6, 7. The length d of the foot section 36 is at most 40%, in particular at most 35%, of the shaft length a of the shaft 8 of the handle 6, 7. The length c of the middle section 35 is at least 20%, in particular at least 30%, of the shaft length a of the shaft 8 of the handle 6, 7.

As shown in FIG. 2, the handle 6, 7 includes a first housing shell 37 and a second housing shell 38. The two housing shells 37, 38 are preferably screwed together. The further shaft 31 is accommodated in the two housing shells 37, 38. Via the housing shells 37, 38, the handle 6, 7 is held clamped on the further shaft 31. The first housing shell 37 forms the inner side 29 of the handle 6, 7. The second housing shell 38 forms the outer side 28 of the handle 6, 7.

It is understood that the foregoing description is that of the preferred embodiments of the invention and that various changes and modifications may be made thereto without departing from the spirit and scope of the invention as defined in the appended claims.

1. A handle for a manually operated work apparatus, the handle comprising:
a shaft having a fastening end and a free end, wherein said shaft extends from said fastening end to said free end over a shaft length (a);
said shaft being fixed at said fastening end;
a first operator-controlled element for controlling the work apparatus;
said first operator-controlled element being arranged adjacent to said free end of said shaft;
an indication arrangement including an indication element for conveying operational information to an operator; and,
said indication arrangement being arranged such that a distance (e) between said indication arrangement and said fastening end is less than half said shaft length (a).

2. The handle of claim 1, wherein said indication element is a display.

3. The handle of claim 1, wherein said indication arrangement includes an additional operator-controlled element for operator input.

4. The handle of claim 3, wherein said additional operator-controlled element is arranged in said display.

5. The handle of claim 1, wherein said indication element is arranged on said shaft of the handle.

6. The handle of claim 1, wherein the handle has an outer side which is provided at least partially for the purpose of resting against a palm of a hand of the operator; the handle has an inner side situated opposite said outer side; and, said indication arrangement is arranged on said inner side of the handle.

7. The handle of claim 1, wherein the handle includes a first holding section; and, said first holding section is formed between said fastening end and said free end of the handle.

8. The handle of claim 1, wherein the handle includes a second holding section; and, said second holding section is formed on said free end of the handle as a support surface for supporting a hand of the operator.

9. The handle of claim 7, wherein the handle includes a second holding section; said second holding section is formed on said free end of the handle as a support surface for supporting a hand of the operator; and, said indication arrangement is arranged outside said first holding section and outside said second holding section.

10. The handle of claim 7, wherein said indication element is arranged between said first holding section and said fastening end.

11. A work apparatus, comprising:
a housing;
a drive motor arranged in said housing;
said drive motor being configured to drive a tool;
a handle having a shaft including a fastening end and a free end;
said shaft extending from said fastening end to said free end over a shaft length (a);
said shaft of said handle being fixed at said fastening end;
said handle having a first operator-controlled element for controlling the work apparatus;
said first operator-controlled element being arranged adjacent to said free end of said shaft;
said handle having an indication arrangement including an indication element for conveying operational information to an operator; and,
said indication arrangement being arranged such that a distance (e) between said indication arrangement and said fastening end is less than half said shaft length (a).

12. The work apparatus of claim 11, wherein said first operator-controlled element is configured to control said drive motor.
